(19) United States
(12) Patent Application Publication
(10) Pub. No.: US 2019/0012777 A1
(43) Pub. Date: Jan. 10, 2019

(54) AUTOMATED VISUAL INSPECTION SYSTEM

(71) Applicants: Rolls-Royce Corporation, Indianapolis, IN (US); Rolls-Royce PLC, London (GB); University of Virginia, Charlottesville, VA (US)

(72) Inventors: Graham Crannell, Charlottesville, VA (US); Peter Beling, Charlottesville, VA (US); Benjamin Choo, Charlottesville, VA (US); Michael Landau, Washington, DC (US); Stephen Adams, Charlottesville, VA (US); Ann Bolcavage, Indianapolis, IN (US); Roy Peter McIntyre, Derby (GB)

(21) Appl. No.: 15/644,559

(22) Filed: Jul. 7, 2017

(51) Int. Cl. G06T 7/00; H04N 5/225; G06T 7/11; G06T 7/60; G06K 9/62; G06T 7/13; G06T 7/194; G01N 21/88

(52) U.S. Cl. CPC G06T 7/001; H04N 5/2256; G06T 7/11; G06T 7/60; G06K 9/6202; G06T 5/002; G06T 7/13; G06T 7/194; G01N 21/8851; G06T 2207/30164; G06K 9/6215

(57) ABSTRACT

An example apparatus for measuring a feature of a tested component may include a lighting device, an imaging device, and a computing device. The computing device may receive, from the imaging device, a plurality of images the tested component in a plurality of states. The computing device may segment each image to isolate target areas from background areas. The computing device may measure a plurality of lengths of the target areas and compare corresponding lengths of two or more of the images.

### TECHNICAL FIELD

The present disclosure generally relates to systems and techniques for automated visual inspection of components.

### BACKGROUND

The components of high-temperature mechanical systems, such as, for example, gas turbine engines, operate in severe environments. For example, the high-pressure turbine blades and vanes exposed to hot gases in commercial aeronautical engines typically experience surface temperatures of about 1000° C., with short-term peaks as high as 1100° C.

Components of high-temperature mechanical systems may include a superalloy substrate, a ceramic substrate, or a ceramic matrix composite (CMC) substrate. In many examples, the substrates may be coated with one or more coatings to modify properties of the surface of the substrate. For example, superalloy substrates may be coated with a thermal barrier coating to reduce heat transfer from the external environment to the superalloy substrate. Ceramic or CMC substrates may be coated with an environmental barrier coating to reduce exposure of the ceramic or CMC substrate to environmental species, such as oxygen or water vapor. Additionally, certain components may include other functional coatings, such as abradable coatings for forming seals between moving parts, abrasive coatings to provide toughness to moving components that may contact abradable coatings, or the like.

### SUMMARY

In some examples, the disclosure describes an apparatus for measuring a feature of a tested component. The apparatus may include a lighting device configured output light to illuminate at least a portion of the tested component, an imaging device, and a computing device. The computing device may be configured to receive, from the imaging device, a first image of the portion of the tested component in a first state; segment the first image to isolate a first target area of the image from background areas of the first image; and measure a plurality of first lengths of at least one portion of the first target area. The computing device also may be configured to receive, from the imaging device, a second image of the portion of the tested component in a second, different state; segment the second image to isolate a second target area of the second image from background areas of the second image; and measure a plurality of second lengths of at least one portion of the second target area, wherein a respective first length of the plurality of first lengths corresponds to a respective second length of the plurality of second lengths. The computing device also may be configured to compare each respective first length of the plurality of first lengths to the corresponding second length of the plurality of second lengths.

In some examples, the disclosure describes a method for measuring a feature of a tested component. The method may include controlling, by a computing device, a lighting device to illuminate at least a portion of a tested component. The method may also include controlling, by the computing device, an imaging device to acquire a first image of the portion of the tested component in a first state. The method may also include segmenting, by the computing device, the first image to isolate a first target area of the image from background areas of the first image. The method may also include measuring, by the computing device, a plurality of first lengths of at least one portion of the first target area. The method may also include controlling, by the computing device, the imaging device to acquire a second image of the portion of the tested component in a second, different state. The method may also include segmenting, by the computing device, the second image to isolate a second target area of the second image from background areas of the second image. The method may also include measuring, by the computing device, a plurality of second lengths of at least one portion of the second target area, wherein a respective first length of the plurality of first lengths corresponds to a respective second length of the plurality of second lengths. The method may also include comparing, by the computing device, each respective first length of the plurality of first lengths to the corresponding second length of the plurality of second lengths.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is conceptual and schematic block diagram illustrating an example system for measuring and comparing target areas of a tested component.

FIG. 2 is a conceptual and schematic block diagram illustrating an example computing device configured to control measurement of and compare masked, grit blasted, or coated target areas of a tested component.

FIG. 3 is a flow diagram of an example technique for measuring and comparing target areas of a tested component.

FIGS. 4-6 are conceptual diagrams illustrating an example plurality of target areas of an image of a tested component.

FIG. 7 is an example graphical display illustrating a distribution of lengths of a target area of an image of a tested component.

FIGS. 8-12 are example graphical displays illustrating lengths of a target area of an image of a tested component.

FIG. 13 is an example graphical display illustrating a distribution of lengths of a target area of an image of a tested component.

### DETAILED DESCRIPTION

The disclosure describes example systems and techniques for measuring a feature of a tested component using a lighting device configured output light to illuminate at least a portion of the tested component, an imaging device, and a computing device. The computing device may receive, from the imaging device, a first image of the portion of the tested component in a first state. The computing device may also segment the first image to isolate a first target area of the image from background areas of the first image. The first target area may be an area whose one or more dimensions are to be measured (e.g., lengths of line segments traversing any portion of first target area may be measured). The computing device may measure a plurality of first lengths of at least a portion of the first target area. The computing device may receive, from the imaging device, a second image of the portion of the tested component in a second state. The computing device may segment the second image to isolate a second target area of the second image from background areas of the second image. The second target area may be an area whose one or more dimensions are to be measured. The computing device may measure a plurality of second lengths of at least a portion of the second target area. A location at which each of the plurality of first lengths is measured may correspond to a location at which a respective second length of the plurality of second lengths is measured. The computing device may compare a respective first length to a corresponding second length. By comparing the respective first lengths to corresponding second lengths, the computing device may determine whether a difference between each respective first length and the corresponding second length is within a predetermined tolerance, whether the first target area substantially corresponds to the second target area, whether the second target area is within or out of a predetermined tolerance, or the like.

The components of high-temperature mechanical systems, such as, for example, gas turbine engines, may include a superalloy substrate, a ceramic substrate, a CMC substrate, or the like, having one or more coatings. For example, gas turbine engine components may include at least one of a bond coat, a calcia-magnisia-aluminosilicate (CMAS)-resistance layer, an environmental barrier coating (EBC), a thermal barrier coating (TBC), an abradable coating, an abrasive coating, or the like. Each of the one or more coatings may have unique mechanical properties, chemical properties, or both to contribute to the performance of an article. For example, an abrasive coating may be confined to a portion of a turbine blade fin tip to facilitate formation of a channel in an abradable coating of a shroud ring of the gas turbine engine during an engine break-in period. Formation of a channel in the abradable coating of the shroud ring may enhance engine efficiency by reducing air flow past the tips of the turbine blade.

Application of a coating to a substrate, e.g., a turbine blade tip, may include a number of processing steps, for example, masking, grit blasting, applying a bond coat, and/or applying a top coat to a portion of the substrate. The mechanical integrity of the top coat may be affected by, for example, the spatial relationship (e.g., the area and the position, relative to one another) of the masked portion of the substrate, the grit blasted portion of the substrate, the bond coated portion of the substrate, and/or the top coated portion of the substrate. For example, application of the bond coat to a portion of a substrate that is not grit blasted may affect the adhesion of the bond coat (and, thereby, adhesion of the abrasive coating) to the substrate. As another example, application of the top coat to a portion of the substrate that does not include a bond coat may affect the adhesion of the top coat to the substrate. Therefore, before or after any step of a coating process, it may be useful to determine the spatial relationship of any one of the masked, grit blasted, bond coated, or top coated portions of the substrate.

The systems and techniques of the disclosure may enable automated visual inspection of a portion of a substrate (e.g., a turbine blade tip) to determine the spatial relationship of a masked, grit blasted, bond coated, or top coated portions of the substrate. For example, the systems and techniques of the disclosure may measure a plurality of first lengths of at least one portion of a first target area of a tested component in a first state (e.g., before or after masking, grit blasting, or bond coating). The systems and technique of the disclosure also may measure a plurality of second lengths of at least one portion of a second target area of the tested component in a second state (e.g., before or after a subsequent step of a coating process). Respective first lengths of the plurality of first lengths may correspond to respective second lengths of the plurality of second lengths. The systems and techniques of this disclosure may compare a respective first length to a corresponding respective second length. The systems and techniques may utilize the comparison of the respective first length and the corresponding respective second length to determine whether a difference between the respective first length and the respective second length is within a predetermined tolerance, whether the first target area substantially corresponds to the second target area, whether the second target area is within a predetermined tolerance, or the like.

For example, a respective first length of the plurality of first lengths may correspond to a length of a portion of the target area of the tested component after grit blasting, and a respective second length of the plurality of second lengths may correspond to a length of a portion of the target area of the tested component after application of a bond coat. Comparison of the respective first and the respective second lengths may enable determination of the distance the edge of the bond coat area from the edge of the grit blasted area. In this way, the disclosure describes systems and techniques to quantify the spatial relationship of the masked, grit blasted, and/or coated portions of a substrate more quickly and accurately than other systems and techniques.

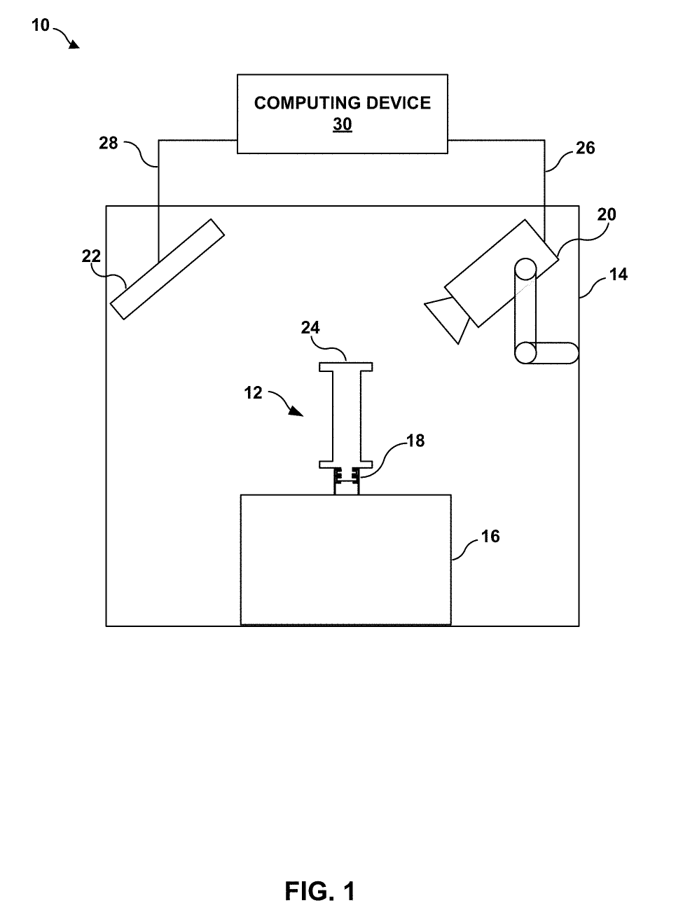

FIG. 1 is conceptual and schematic block diagram illustrating an example system 10 for measuring and comparing target areas of a tested component 12. System 10 may include an enclosure 14 defining an inspection station. System 10 also may include stage 16, mount 18, imaging device 20, and lighting device 22, which may be disposed within enclosure 14. Enclosure 14 may be any suitable size or shape to at least partially enclose tested component 12, stage 16, mount 18, imaging device 20, and lighting device 22. In some examples, enclosure 14 may be sized or shaped to allow an operator to insert or remove any of tested component 12, stage 16, mount 18, imaging device 20, and lighting device 22 to and from enclosure 14.

Mount 18 may be configured to receive and detachably secure tested component 12, e.g., relative to imaging device 20 and lighting device 22. For example, mount 18 may be shaped to receive a root section (e.g., fir tree section) of a turbine blade. Mount 18 may further include a clamp (e.g., spring clamp, bolt clamp, vise, or the like) or another fastener configured to detachably secure tested component 12 on stage 16.

Imaging device 20 may be configured to acquire a digital image of at least a portion 24 of tested component 12. For example, imaging device 20 may include a fixed or variable focal length lens, a fixed or variable aperture, a shutter, a shutter release, an image sensor (e.g., a charge-coupled device, a complementary metal-oxide semiconductor, or the like), or the like. Imaging device 20 may include fewer or additional components.

Lighting device 22 may be configured to output light to illuminate at least a portion 24 of tested component 12. Lighting device 22 may include any suitable light source, such as, e.g., one or more of LED lamps, incandescent bulbs, fluorescent lamps, halogen lamps, metal halide lamps, sulfur lamps, high- or low-pressure sodium lamps electrodeless lamps, or the like. In some examples, lighting device 22 may include an LED strip. For example, lighting device 22 may include an LED strip that may span a portion of enclosure 14 to illuminate tested component 12 from a plurality of angles.

Computing device 30 may include, for example, a desktop computer, a laptop computer, a tablet computer, a workstation, a server, a mainframe, a cloud computing system, or the like. Computing device 30 is configured to control operation of system 10 including, for example, stage 16, mount 18, imaging device 20, and lighting device 22. Computing device may be communicatively coupled to at least one of stage 16, mount 18, imaging device 20, or lighting device 22 using respective communication connections. In some examples, the communication connection may include network links, such as Ethernet or other network connections. Such connection may be wireless and/or wired connections. In other examples, the communications connections may include other types of device connections, such as, USB, IEEE 1394, or the like. For example, computing device 30 may be communicatively coupled to imaging device 20 via wired or wireless imaging device connection 26 and/or lighting device 22 via wired or wireless lighting device connection 28.

Although not shown in FIG. 1, system 10 may include one or more power sources. In some examples, one or more power source may be electrically coupled to each of computing device 30, imaging device 20, and lighting device 22. In other examples, one or more power sources may be electrically coupled to computing device 30, which may be electrically couple each of imaging device 20 and lighting device 22 via imaging device connection 26 and lighting device connection 28, respectively.

Computing device 30 may be configured to control operation of at least one of stage 16, mount 18, imaging device 20, or lighting device 22 to position tested component 12 relative to imaging device 20, lighting device 22, or both. For example, one or both of stage 16 and mount 18 may be translatable, rotatable, or both along at least one axis to position tested component 12 relative to imaging device 20. Similarly, imaging device 20 may be translatable, rotatable, or both along at least one axis to position tested component 12 relative to one or both of stage 16 and mount 18. Computing device 30 may control any one or more of stage 16, mount 18, or imaging device 20 to translate and/or rotate along at least one axis to position tested component 12 relative to imaging device 20. Positioning tested component 12 relative to imaging device 20 may include positioning at least portion 24 of tested component 12 to be imaged using imaging device 24. In some examples, computing device 30 may record an initial position of any one or more of stage 16, mount 18, or imaging device 20. In this way, computing device 30 may enable repeatable imaging of a plurality of tested components.

Computing device 30 also may be configured to control operation of lighting device 22. For example, computing device 30 may be configured to control a power delivered to one or more light sources within lighting device 22 to control intensity of light output by lighting device 22. Further, computing device 30 may be configured to control lighting device 22 to output light of a selected wavelength (e.g., one or more wavelength ranges). For example, lighting device 22 may include one or more LED packages. An LED package may include one or more of individual red, green, and blue (RGB) LEDs, and a controller to selectively control power, or a percentage of power, to one or more of the individual RGB LEDs. Computing device 30 may control an LED package to output light of a selected wavelength or wavelength range. In this way, computing device 30 may be configured to control lighting device 22 to output light to illuminate at least portion 24 of tested component 12 with a selected intensity and wavelength range of light. In some examples, the intensity or wavelength range of light illuminating portion 24 may affect the contrast of one or more portions of an image of portion 24 acquired by imaging device 20. In this way, lighting device 24 may selectively control the contrast of one or more portions of an image acquired by imaging device 20.

Computing device 30 may be configured to control imaging device 20 to acquire images of tested component 12. For example, computing device 30 may control imaging device 20 to capture a plurality of images of at least portion 24 of tested component 12 and may receive data representative of the plurality of images from imaging device 20. Computing device 30 may compare at least one feature of at least two of the plurality of images.

In some examples, each of the plurality of images may correspond to a respective state of the tested component 12. Each state may be a different stage of a manufacturing process by which tested component 12 is formed. For example, a first state may be after casting, forging, additive manufacturing, or the like to form a substrate of tested component 12; a second stage may be after grit blasting of the substrate; a third state may be after masking of the substrate; a fourth state may be after forming a bond coating on a selected area of the substrate; and a fifth state may be after forming a top coating on a selected area of the substrate. In some examples, each of the plurality of images may correspond to four states of the tested component 12, including after masking, after grit blasting, after bond coating, and after top coating. Other states are possible, depending on the manufacturing process used to form tested component 12.

For example, computing device 30 may receive, from imaging device 22, data representative of a first image of portion 24 of tested component 12 in a first state. Similarly, computing device 30 may receive, from imaging device 22, data representative of a second image of portion 24 of tested component 12 in a second state. In some examples, computing device 30 may receive, from imaging device 22, data representative of a standard component image of a portion of a standard component (e.g., a portion 24 of tested component 12 that is representative of a plurality of tested components). In some examples, computing device 30 may be configured to retrieve a stored image, e.g., a first image, second image, standard image, or the like. In this way, computing device 30 may receive a plurality of images, each image corresponding to one or more states of a plurality of tested components.

In some examples, computing device 30 may be configured to condition an image. For example, to condition an image, computing device 30 may remove artifacts from the image, resize a portion of the image, deform a portion of the image, transform a portion of the image, adjust a wavelength of light emitted from lighting device, adjust a color of a portion of the image, adjust a contrast of a portion of the image, or the like. As another example, to condition an image, computing device 30 may determine that an image should be reacquired; adjust at least one of a focal length of the imaging device, a position of one or more of stage 16, mount 18, imaging device 20, and lighting device 22, or an output light wavelength range or intensity of lighting device 22; and reacquire the image. In some examples, image conditioning may result in an image that computing device 30 can more easily segment. In this way, computing device 30 may improve the speed and/or accuracy of subsequent image analysis by conditioning the image (e.g., image segmentation, feature measurement, or the like).

In some examples, computing device 30 also may segment an image to isolate a target area of the image from background areas of the image. For example, computing device 30 may isolate a target area (e.g., portion 24) of an image from the background (e.g., other non-target areas of tested component 12, enclosure 14, or the like) of the image. In other examples, computing device 30 may segment an image to isolate a plurality of target areas of the image from background areas of the image.

In some examples, computing device 30 may use active contouring, edge detection, or the like to segment the image. In some examples, active contouring may find the boundaries of an object in an image. In some examples, edge detection may include one or more mathematical algorithms that may identify points in an image where the brightness, contrast, or the like changes. Active contouring or edge detection may include identifying, by computing device 30, a first search region. The first search region may include a single pixel or a plurality of pixels in the image. For example, the first search region may be based on at least one of user input, a predetermined portion of an initial target area (e.g., portion 24), or the like. For example, computing device 30 may segment a standard component image to isolate a standard target area of the standard component image from background areas of the standard component image to determine a first search region based on a predetermined portion of the standard target area. Next, computing device 30 may identify a second, adjacent search region that is a predetermined distance in one or more predetermined directions from the first search region. The second search region may include a single pixel or a plurality of pixels in the image. Computing device 30 may then determine whether a difference in contrast between the first search region and the second search region is greater than predetermined threshold (e.g., whether the first search region and second search region include a high contrast area). Computing device 30 may repeat identifying subsequent search regions and determining whether a difference in contrast between a preceding search region and a subsequent search region is greater than predetermined threshold to identify a plurality of high contrast areas.

In some examples, the plurality of high contrast areas may define a boundary of the target area of an image acquired by imaging device 22. For example, a first plurality of high contrast areas may define a first boundary of a first target area of portion 24 of tested component 12 in a first state. Similarly, a second plurality of high contrast areas may define a second boundary of a second target area of tested component 12 in a second state. In some examples, computing device 30 may be configured to segment a plurality of images, each image corresponding to a respective tested component of a plurality of tested components or to a respective state of a tested component. For example, computing device 30 may segment a first image of portion 24 of tested component 12 in a first state and segment a second image of portion 24 of tested component 12 in a second state. In this way, computing device 30 may segment a plurality of images to improve the speed and/or accuracy of subsequent image analysis (e.g., measurement of a plurality of lengths of the target area of an image).

Computing device 30 also may measure a plurality of lengths of at least one portion of a target area. For example, computing device 30 may be configured to identify a respective first position of a plurality of first positions on a first side of a boundary of the target area. Computing device 30 may determine the first side of the boundary of the target area. For example, computing device 30 may determine the first side of the boundary based on at least one of a dimension, a coordinate position, or an orientation of at least a portion of a target area. In some examples, computing device 30 may determine at least one straight line to approximate at least one side of the boundary of the target area. For example, computing device may determine a linear regression based on at least a portion of the first plurality of high contrast areas that defines the first side of the boundary. Computing device 30 may determine a plurality of line segments extending at a predetermined angle from the at least one straight line. For example, computing device 30 may determine a plurality of line segments extending substantially perpendicular to a linear regression line that approximates the first side of the boundary. Computing device 30 may determine a first respective first position at an intersection of the first side of the boundary and a first line extending at a predetermined angle from a first position on the straight line. In some examples, computing device 30 may determine a second respective first position at an intersection of the boundary line and a second line extending at a predetermined angle from a second position on the straight line. In other examples, computing device 30 may determine a plurality of line segments extending from the first side of the boundary based on the orientation of the pixels of the image. For example, the image may include a plurality of pixel columns (or rows). A first respective pixel column of the plurality of pixel columns (e.g., one or more pixels in width) may intersect the first side of the boundary at a first respective first position of a plurality of first positions. A second respective pixel column of the plurality of pixel columns may intersect the first side of the boundary at a second respective first position of a plurality of first positions. In this way, computing device 30 may determine a plurality of first positions on a first side of a boundary of the target area.

Computing device 30 then may identify a respective second position of a plurality of second positions on a second opposing side of the boundary of the target area. In some examples, computing device 30 may determine the respective second position at an intersection of the second opposing side of the boundary and the first line extending at a predetermined angle from a first position on the straight line. In other examples, the plurality of second positions on a second opposing side of the boundary of the target area may be determined in substantially the same manner as described above with respect to the plurality of first positions, except that the straight line may be fit to the second opposing boundary. Computing device 30 then may assign, by a predetermined process, a respective first position to a corresponding second position. In other examples, a respective pixel column of the plurality of pixel columns may interest the second side of the boundary at a corresponding second position of the plurality of second positions. In this way, computing device 30 may determine each respective first position of a plurality of first position and a corresponding second position of the plurality of second positions.

In some examples, a plurality of vectors extending from each respective first position to a corresponding second position may be substantially parallel. In other examples, a plurality of vectors extending from each respective first position to a corresponding second position may not be substantially parallel, e.g., one or more vectors may converge or diverge.

Once computing device 30 has identified a plurality of first positions and a plurality of corresponding second positions, computing device 30 may determine a plurality of lengths between the respective first positions of the plurality of first positions and the respective corresponding second positions of the plurality of second positions. In some examples, each of the plurality of lengths may include chains of image pixels (e.g., columns or rows of pixels that may be one or more pixels in width) extending from a respective first position to a corresponding second position. For example, computing device 30 may identify respective first positions of a plurality of first positions on a first side of a first boundary of a first target area of tested component 12 in a first state, identify respective second positions of a plurality of second positions on a second opposing side of the first boundary of the first target area of portion 24 of tested component 12 in a first state, and determine a plurality of first lengths (e.g., respective lengths of a plurality of pixel chains) between the respective first positions and the corresponding respective second positions. In some examples, computing device 30 may convert each of the plurality of lengths from a number of pixels in a pixel chain to a unit of length (e.g., millimeters) based on a predetermined pixel-to-length ratio.

Computing device 30 may repeat the active contouring, edge detection, or the like for a second target area of tested component 12 in a second state. For example, computing device 30 may identify respective third position of a plurality of third positions and corresponding fourth positions of a plurality of fourth positions on a boundary of the second target area. Once computing device 30 has identified a plurality of third positions and a plurality of corresponding fourth positions, computing device 30 may determine a plurality of lengths between the respective third positions and corresponding fourth positions. For example, computing device 30 may identify respective third positions of a plurality of third positions on a first side of a second boundary of a second target area of tested component 12 in a second state, identify respective fourth positions of a plurality of fourth positions on a second opposing side of the second boundary of the second target area of portion 24 of tested component 12 in a second state, and determine a plurality of second lengths (e.g., respective lengths of a plurality of pixel chains) between the respective third positions and the corresponding respective fourth positions.

In some examples, the respective first positions may substantially correspond to the respective third positions, and the respective second positions may substantially correspond to the respective fourth positions. For example, a first vector extending from a respective first position to a corresponding second position may substantially overlap, or otherwise substantially correspond to, a second vector extending from a respective third position to a corresponding fourth position. As such, the locations at which respective first lengths were determined by computing device 30 may correspond to locations at which respective second lengths were determined by computing device 30. In this way, computing device 30 may determine respective first lengths of a plurality of first lengths of at least one portion of a first target area and corresponding second lengths of a plurality of second lengths of at least one portion of a second target area.

Computing device 30 also may compare respective first lengths to corresponding second lengths. For example, computing device 30 may determine a respective difference between each respective first length and corresponding second length. In other examples, computing device 30 may compare statistics based on respective first lengths, corresponding second lengths, or both. For example, computing device 30 may compare the respective average of first lengths and second length, the variance of first lengths and second length, the relative positions of first lengths and second lengths, or the like. In other examples, computing device 30 may use machine learning to estimate a quality of a state of tested component 12 based on respective lengths to corresponding second lengths or statistics derived from respective lengths to corresponding second lengths. In this way, computing device 30 may determine a plurality of target area dimension differences.

Computing device 30 may be configured to analyze the plurality of lengths and/or the plurality of target area dimension differences. For example, computing device 30 may determine whether one or more of the plurality of target area dimension differences is within a predetermined tolerance (e.g., less than a predetermined value). In some examples, in response to determining that one or more of the plurality of lengths is outside a predetermined tolerance, computing device 30 may determine that the second state (e.g., after grit blasting, masking, or a coating step) is out of tolerance. In some examples, computing device 30 may count a number of lengths that is out of tolerance, compare the number of out-of-tolerance lengths to a threshold value, and determine whether the second state is within tolerance based in the comparison. For example, in response to a number of out-of-tolerance lengths being greater than the threshold value, computing device 30 may determine that the second state is out of tolerance. Computing device 30 may be configured to output an indication of whether the second state is within or out of tolerance, e.g., via a user interface device, such as a screen.

In some examples, rather than outputting an indication of whether the second state is out of or within tolerance, computing device 30 may be configured to output a graphical display of at least one of first lengths of the plurality of first lengths, second lengths of the plurality of second lengths, or difference between respective first lengths and respective second lengths. In other examples, computing device 30 may be configured to output a graphical display including one or more statistics based on any one or more of the first lengths, the second lengths, or the differences between respective first lengths and respective second lengths. For example, computing device 30 may statistically analyze at least one of the first lengths, the second lengths, or the differences. In some examples, computing device 30 may be configured to output a histogram indicating the absolute value of a difference between a respective first length and a corresponding second length. In other examples, computing device 30 may be configured to output other statistical analyses of at least one of the first lengths, the second lengths, the differences, or the predetermined tolerances. For example, computing device 30 may be configured to output fits to a given distribution, a measure of similarity between two distributions, analysis of variance, or the like. In some examples, computing device 30 may be configured to output a display of at least one of the first image, the first target area, the second image, or the second target area, and an indication of at least one of the first lengths, the second lengths, the differences, or the predetermined tolerances. In this way, computing device 30 may output a graphical display that may enable evaluation of the spatial relationship of the first state and the second state of tested component 12 (e.g., after casting, forging, or additive manufacturing; after grit blasting; after masking; after bond coating; after top coating; or any other stage of a manufacturing process) to determine if the second state meets a predetermine tolerance.

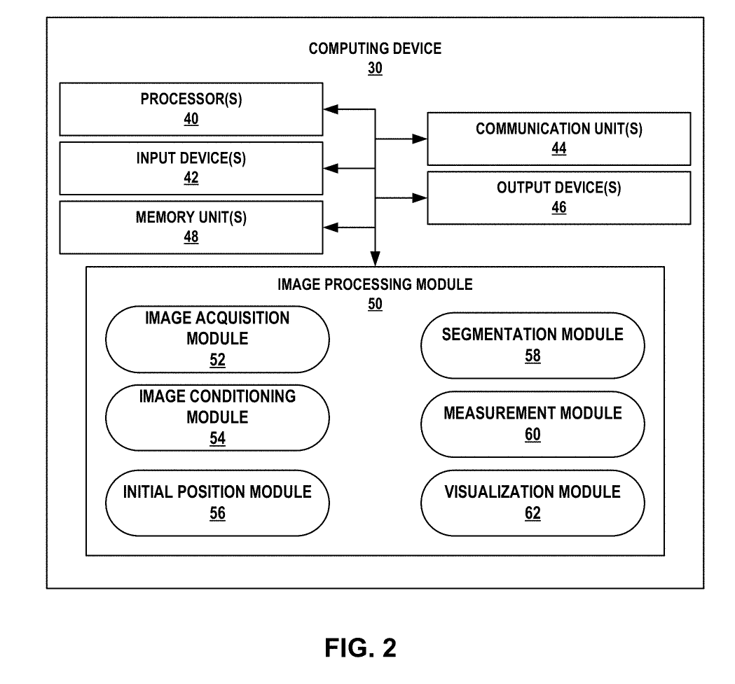

FIG. 2 is a conceptual and schematic block diagram illustrating an example of computing device 30 illustrated in FIG. 1. In the example of FIG. 2, computing device 30 includes one or more processors 40, one or more input devices 42, one or more communication units 44, one or more output devices 46, one or more memory units 48, and image processing module 50. In some examples, image processing module 50 includes image acquisition module 52, image conditioning module 54, initial position module 56, segmentation module 58, measurement module 60, and visualization module 62. In other examples, computing device 30 may include additional components or fewer components than those illustrated in FIG. 2.

One or more processors 40 are configured to implement functionality and/or process instructions for execution within computing device 30. For example, processors 40 may be capable of processing instructions stored by image processing module 50. Examples of one or more processors 40 may include, any one or more of a microprocessor, a controller, a digital signal processor (DSP), an application specific integrated circuit (ASIC), a field-programmable gate array (FPGA), or equivalent discrete or integrated logic circuitry.

Memory units 48 may be configured to store information within computing device 30 during operation. Memory units 48, in some examples, include a computer-readable storage medium or computer-readable storage device. In some examples, memory units 48 include a temporary memory, meaning that a primary purpose of memory units 48 is not long-term storage. Memory units 48, in some examples, include a volatile memory, meaning that memory units 48 does not maintain stored contents when power is not provided to memory units 48. Examples of volatile memories include random access memories (RAM), dynamic random access memories (DRAM), static random access memories (SRAM), and other forms of volatile memories known in the art. In some examples, memory units 48 are used to store program instructions for execution by processors 40. Memory units 48, in some examples, are used by software or applications running on computing device 30 to temporarily store information during program execution.

In some examples, memory units 48 may further include one or more memory units 48 configured for longer-term storage of information. In some examples, memory units 48 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 30 further includes one or more communication units 44. Computing device 30 may utilize communication units 44 to communicate with external devices (e.g., stage 16, mount 18, imaging device 20, and/or lighting device 22) via one or more networks, such as one or more wired or wireless networks. Communication unit 44 may be a network interface card, such as an Ethernet card, an optical transceiver, a radio frequency transceiver, or any other type of device that can send and receive information. Other examples of such network interfaces may include Wi-Fi radios or USB. In some examples, computing device 30 utilizes communication units 44 to wirelessly communicate with an external device such as a server.

Computing device 30 also includes one or more input devices 42. Input devices 42, in some examples, are configured to receive input from a user through tactile, audio, or video sources. Examples of input devices 42 include a mouse, a keyboard, a voice responsive system, video camera, microphone, touchscreen, or any other type of device for detecting a command from a user.

Computing device 30 may further include one or more output devices 46. Output devices 46, in some examples, are configured to provide output to a user using audio or video media. For example, output devices 46 may include a display, a sound card, a video graphics adapter card, or any other type of device for converting a signal into an appropriate form understandable to humans or machines.

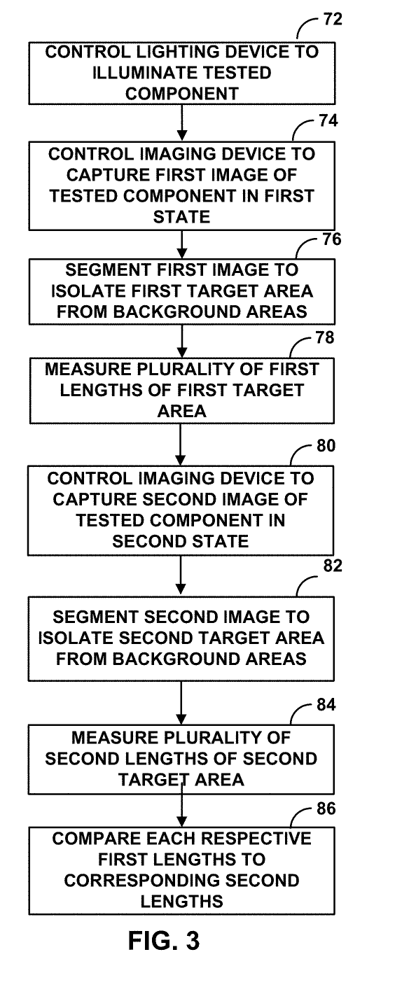

Computing device 30 also may include image acquisition module 52, image conditioning module 54, initial position module 56, segmentation module 58, measurement module 60, and visualization module 62. Image acquisition module 52, image conditioning module 54, initial position module 56, segmentation module 58, measurement module 60, and visualization module 62 may be implemented in various ways. For example, one or more of image acquisition module 52, image conditioning module 54, initial position module 56, segmentation module 58, measurement module 60, and visualization module 62 may be implemented as an application executed by one or more processors 40. In other examples, one or more of image acquisition module 52, image conditioning module 54, initial position module 56, segmentation module 58, measurement module 60, and visualization module 62 may be implemented as part of a hardware unit of computing device 30 (e.g., as circuitry). Functions performed by one or more of image acquisition module 52, image conditioning module 54, initial position module 56, segmentation module 58, measurement module 60, and visualization module 62 are explained below with reference to the example flow diagrams illustrated in FIG. 3.

Computing device 30 may include additional components that, for clarity, are not shown in FIG. 2. For example, computing device 30 may include a power supply to provide power to the components of computing device 30. Similarly, the components of computing device 30 shown in FIG. 2 may not be necessary in every example of computing device 30.

FIG. 3 is a flow diagram of an example technique for measuring and comparing target areas of a tested component. Although the technique of FIG. 3 will be described with respect to system 10 of FIG. 1 and computing device 30 of FIG. 2, in other examples, the technique of FIG. 3 may be performed using a different system and/or different computing device. Additionally, system 10 and computing device 30 may perform other techniques to evaluate the spatial relationship of different states of tested component 12 to determine if the state meets a predetermine tolerance.

The technique illustrated in FIG. 3 includes controlling, by computing device 30 and, more particularly, image acquisition module 52, lighting device 22 to illuminate at least portion 24 of tested component 12 (72). For example, computing device 30 and, more particularly, image acquisition module 52, may control lighting device 22 to output light to illuminate at least portion 24 with a selected intensity and wavelength range of light to improve the contrast of one or more portions of an image acquired by imaging device 20 (e.g., of one or more portions of portion 24).

In some examples, although not shown in FIG. 3, the technique may include controlling, by computing device 30 and, more particularly, image acquisition module 52, a position of any one or more of stage 16, mount 18, imaging device 20, and lighting device 22 to position tested component 12 relative to imaging device 20, lighting device 22, or both. For example, computing device 30 and, more particularly, image acquisition module 52, may control any one of stage 16, mount 18, or imaging device 20 to translate and/or rotate along at least one axis to position tested component 12 relative to imaging device 20. Computing device 30 may store, in memory units 48, an initial portion of stage 16, mount 18, imaging device 20, or lighting device 22 to facilitate repeatable imaging of a tested component 12 at different states or repeatable imaging of a plurality of tested components.

The technique illustrated in FIG. 3 includes controlling, by computing device 30 and, more particularly, image acquisition module 52, imaging device 20 to capture a first image of portion 24 of tested component 12 in a first state (74). As discussed above with reference to FIG. 1, the first state of tested component 12 may include a stage of a manufacturing process by which tested component 12 is formed, e.g., after casting, forging, or additive manufacturing; after grit blasting; after masking; after bond coating; after top coating; or any other stage of a manufacturing process.

The technique illustrated in FIG. 3 includes receiving, by computing device 30 and, more particularly, image acquisition module 52, from imaging device 20, data representative of the first image. For example, computing device 30 and, more particularly, image acquisition module 52, may receive, from imaging device 22, data representative of a first image of portion 24 of tested component 12 in a first state, data representative of a second image of portion 24 of tested component 12 in a second state, or data representative of a standard component image of a portion of a standard component. In this way, the technique of FIG. 3 may include receiving, by computing device 30 and, more particularly, image acquisition module 52, a plurality of images, each image corresponding to one or more states of a plurality of tested components.

In some examples, the technique illustrated in FIG. 3 may also include conditioning, by computing device 30 and, more particularly, conditioning module 54, the first image. For example, conditioning an image may include removing artifacts in the image, adjusting a color of the image, adjusting a contrast of the image, or the like. As another example, conditioning an image may include determining that an image should be reacquired; adjusting at least one of a focal length of the imaging device, a position of one or more of stage 16, mount 18, imaging device 20, and lighting device 22, an output light wavelength range or intensity of lighting device 22; and reacquiring the image. In this way, conditioning, by computing device 30 and, more particularly, conditioning module 54, the first image may improve the speed and/or accuracy of subsequent image analysis (e.g., image segmentation, feature measurement, or the like).

The technique illustrated in FIG. 3 includes segmenting, by computing device 30 and, more particularly, segmentation module 58, the first image to isolate a first target area of the first image from background areas of the first image (76). For example, segmenting the first image may include using active contouring or edge detecting, as discussed above with reference to FIG. 1, to isolate a target area of the first image, e.g., by identifying a boundary of the first target area. In some examples, technique illustrated in FIG. 3 may include segmenting, by computing device 30 and, more particularly, segmentation module 58, the first image to isolate a plurality of target areas of the first image from background areas of the first image

Segmenting the first image by computing device 30 and, more particularly, segmentation module 58, may be substantially similar as discussed above with reference to FIG. 1. For example, segmenting the first image may include identifying, by computing device 30 and, more particularly, segmentation module 58, a first search region. Segmenting may also include identifying, by computing device 30 and, more particularly, segmentation module 58, a second, adjacent search region. Segmenting may also include determining, by computing device 30 and, more particularly, segmentation module 58, whether a difference in contrast between the first search region and the second search region is greater than predetermined threshold. Segmenting may also include repeating, by computing device 30 and, more particularly, segmentation module 58, identifying subsequent search regions and determining whether a difference in contrast between a preceding search region and a subsequent search region is greater than predetermined threshold to identify a plurality of high contrast areas.

For example, the technique of FIG. 3 may include determining, by computing device 30 and, more particularly, segmentation module 58, a first plurality of high contrast areas in or near the first target area. The first plurality of high contrast areas may define a first boundary of a first target area of portion 24 of tested component 12 in a first state. Similarly, the technique of FIG. 3 may include determining, by computing device 30 and, more particularly, segmentation module 58, a second plurality of high contrast areas in or near a second target area. The second plurality of high contrast areas may define a second boundary of a second target area of tested component 12 in a second state.

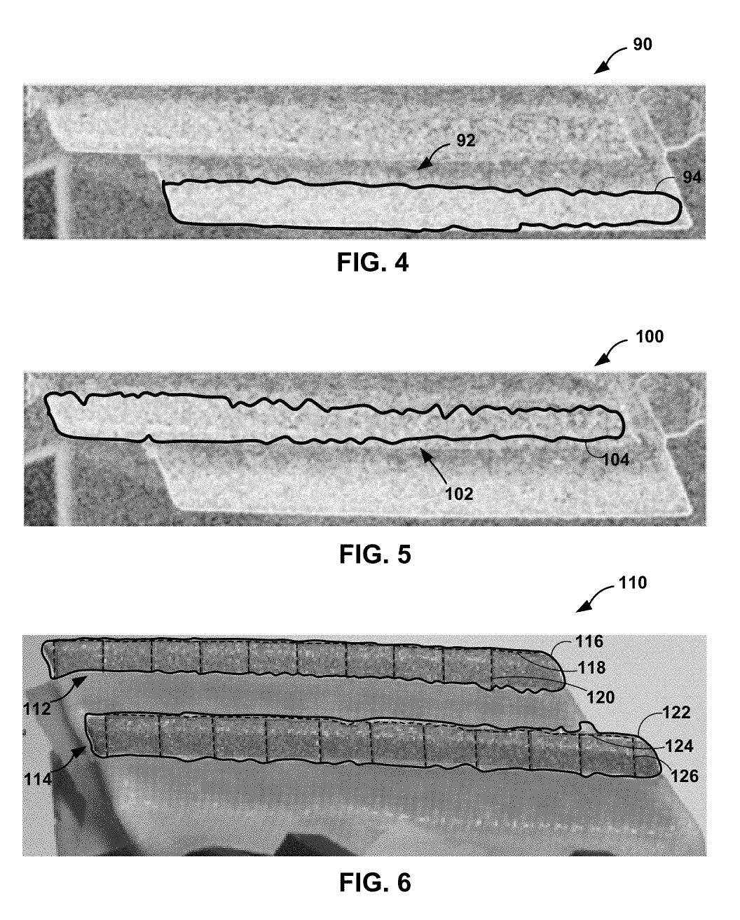

In some examples, the technique illustrated in FIG. 3 may include segmenting, by computing device 30 and, more particularly, segmentation module 58, the first image to isolate a plurality of target areas of the image from background areas of the first image. For example, FIGS. 4 and 5 are conceptual diagrams 90 and 100 illustrating two example first target areas 92 and 102 of a first image of a tested component. As shown in FIGS. 4 and 5, after segmenting the first image, target areas, e.g., 92 and 102, may be represented by a boundary, e.g., boundaries 94 and 104. In this way, segmenting, by computing device 30 and, more particularly, segmentation module 58, a plurality of images may improve the speed and/or accuracy of subsequent image analysis (e.g., measuring of a plurality of lengths of the target area of an image).

The technique illustrated in FIG. 3 includes measuring, by computing device 30 and, more particularly, measurement module 60, a plurality of first lengths of at least one portion of the first target area (82). For example, measuring, by computing device 30 and, more particularly, measurement module 60, a plurality of first lengths may include, as discussed above with reference to FIG. 1, identifying a respective first position of a plurality of first positions on a first side of a boundary of a target area. Measuring, by computing device 30 and, more particularly, measurement module 60, a plurality of first lengths may also include, as discussed above with reference to FIG. 1, identifying a respective second position of a plurality of second positions on a second opposing side of the boundary of the target area. Measuring, by computing device 30 and, more particularly, measurement module 60, a plurality of first lengths may also include, as discussed above with reference to FIG. 1, determining a plurality of lengths between the respective first position of the plurality of first positions and the respective corresponding second position of the plurality of second positions.

The technique illustrated in FIG. 3 includes controlling, by computing device 30 and, more particularly, image acquisition module 52, imaging device 20 to acquire a second image of the portion of tested component 12 in a second state (80). Controlling, by computing device 30 and, more particularly, image acquisition module 52, imaging device 20 to acquire the second image may be performed in the same or substantially the same manner as described above with reference to step (74).

In some examples, the technique illustrated in FIG. 3 may include controlling, by computing device 30 and, more particularly, image acquisition module 52, imaging device 20 to acquire a standard component image of a portion of a standard component. In some examples, the technique illustrated in FIG. 3 may include segmenting, by computing device 30 and, more particularly, segmentation module 58, the standard component image to isolate a standard target area of the standard component image from background areas of the standard component image. In some examples, the technique illustrated in FIG. 3 may include determining, by computing device 30 and, more particularly, segmentation module 58, based on the standard target area, at least one of at least one portion of the first target area or at least one portion of the second target area.

The technique illustrated in FIG. 3 includes segmenting, by computing device 30, and, more particularly, segmentation module 58, the second image to isolate a second target area of the second image from background areas of the second image (82). Segmenting, by computing device 30 and, more particularly, segmentation module 58, the second image may be performed in the same or substantially the same manner as described above with reference to step (76).

The technique illustrated in FIG. 3 includes measuring, by computing device 30 and, more particularly, measurement module 60, a plurality of second lengths of at least one portion of the second target area, where a respective first length of the plurality of first lengths corresponds to a respective second length of the plurality of second lengths (84). Measuring, by computing device 30 and, more particularly, measurement module 60, a plurality of second lengths may be performed in the same or substantially the same manner as described above with reference to step (78).

The technique illustrated in FIG. 3 includes comparing, by computing device 30 and, more particularly measurement module 60, each respective first length of the plurality of first lengths to the corresponding second length of the plurality of second lengths (86). For example, as discussed above with reference to FIG. 1, comparing, by computing device 30 and, more particularly measurement module 60, each respective first length to the corresponding second length may include determining a respective difference between each respective first length and the corresponding second length. In this way, the technique of FIG. 3 may include determining a plurality of target area dimension differences for a plurality of first lengths and a corresponding plurality of second lengths.

In some examples, the technique illustrated in FIG. 3 may include analyzing, by computing device 30 and, more particularly measurement module 60, a plurality of lengths and/or a plurality of target area dimension differences. In some examples, analyzing a plurality of lengths and/or a plurality of target area dimension differences may include determining, by computing device 30 and, more particularly measurement module 60, whether a difference between each respective first length of the plurality of first lengths and the corresponding second length of the plurality of second lengths is within a predetermined tolerance (e.g., less than a predetermined value). In some examples, in response to determining that one or more of the plurality of lengths is outside a predetermined tolerance, computing device 30 may determine that the second state (e.g., after grit blasting, masking, or a coating step) is out of tolerance. In some examples, analyzing, by computing device 30 and, more particularly measurement module 60, may include counting a number of lengths that is out of tolerance, comparing the number of out-of-tolerance lengths to a threshold value, and determining whether the second state is within tolerance based in the comparison. For example, in response to a number of out-of-tolerance lengths being greater than the threshold value, analyzing, by computing device 30 and, more particularly measurement module 60, may include determining that the second state is out of tolerance. Computing device 30 may be configured to output an indication of whether the second state is within or out of tolerance, e.g., via a user interface device, such as a screen.

In some examples, the technique illustrated in FIG. 3 may also include outputting, by computing device 30 and, more particularly, visualization module 62, a display of at least one of the first image, the first target area, the second image, or the second target area, and an indication of at least one of the at least one first length of the plurality of first lengths, the at least one second length of the plurality of second lengths, or the difference between the at least one first length of the plurality of first lengths and the at least one second length of the plurality of second lengths. For example, FIG. 6 is a conceptual diagram 110 illustrating an example plurality of target areas of an image of tested component 12. The example of FIG. 6 shows an image of tested component 12 superimposed with an indication of a first target area and a second target area, together with an indication of a plurality of lengths (of the second target area). For example, FIG. 6 shows two target areas 112 and 114 of an image of tested component 12. The two target areas 112 and 114 each include a respective first target area boundary 116 and 122 (e.g., indicated by a solid line). The two target areas 112 and 114 also include a respective second target area boundary 118 and 124 (e.g. indicated by a dashed line). As shown in FIG. 6, the two target areas 112 and 114 each include an indication of a plurality of lengths of the second target area 120 and 126 (e.g., indicated by dashed lines). In this way, the technique of FIG. 3 may include outputting a display to allow evaluation of the spatial relationship of any one of the masked portion of the substrate, the grit blasted portion of the substrate, the bond coated portion of the substrate, and/or the top coated portion of the substrate to determine if the masked portion of the substrate, the grit blasted portion of the substrate, the bond coated portion of the substrate meets a predetermine tolerance.

In other examples, the technique illustrated in FIG. 3 may also include outputting, by computing device 30 and, more particularly, visualization module 62, a graphical display of at least one of the at least one first length of the plurality of first lengths, at least one second length of the plurality of second lengths, or at least one difference between each respective first length of the plurality of first lengths and the corresponding second length of the plurality of second lengths, or at statistical analysis of thereof.

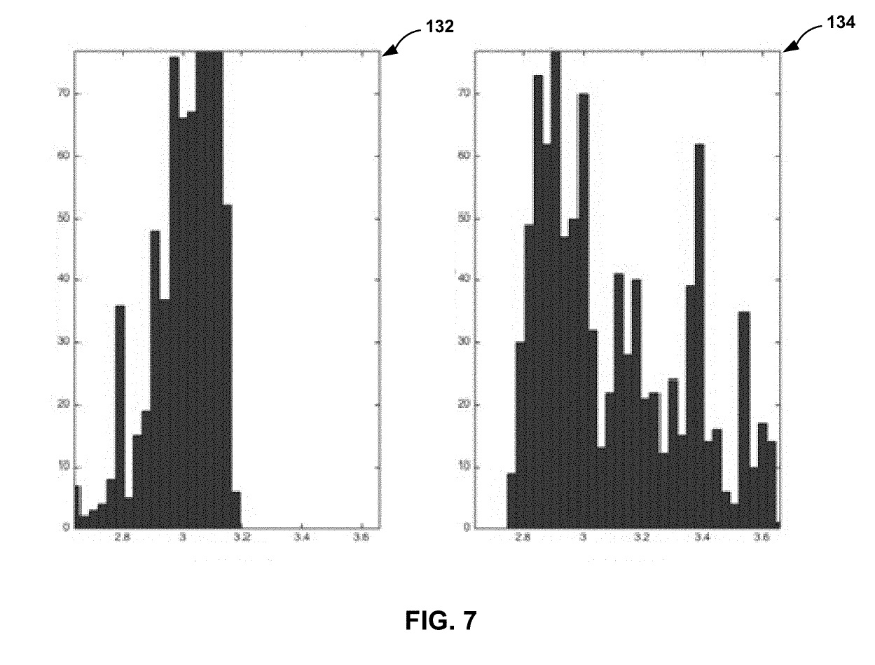

For example, FIG. 7 is an example graphical display illustrating a distribution of lengths of a target area of an image of a tested component. The example graphical display of FIG. 7 shows histograms 132 and 134, one for each of two target regions, indicating on the y-axis a number of lengths of a plurality of lengths with a difference between respective first lengths of the plurality of first lengths and corresponding second lengths of the plurality of second lengths within a particular range on the x-axis. The histograms shown in FIG. 7 may be used, for example, by operators to evaluate the spatial relationship of any one of the masked portion of the substrate, the grit blasted portion of the substrate, the bond coated portion of the substrate, and/or the top coated portion of the substrate to determine if the masked portion of the substrate, the grit blasted portion of the substrate, the bond coated portion of the substrate meets a predetermine tolerance.

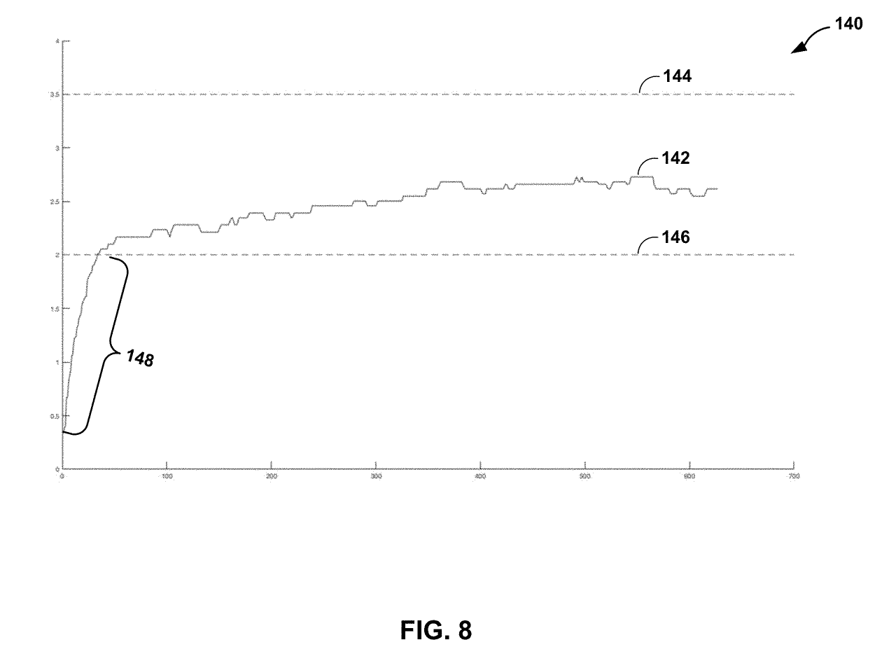

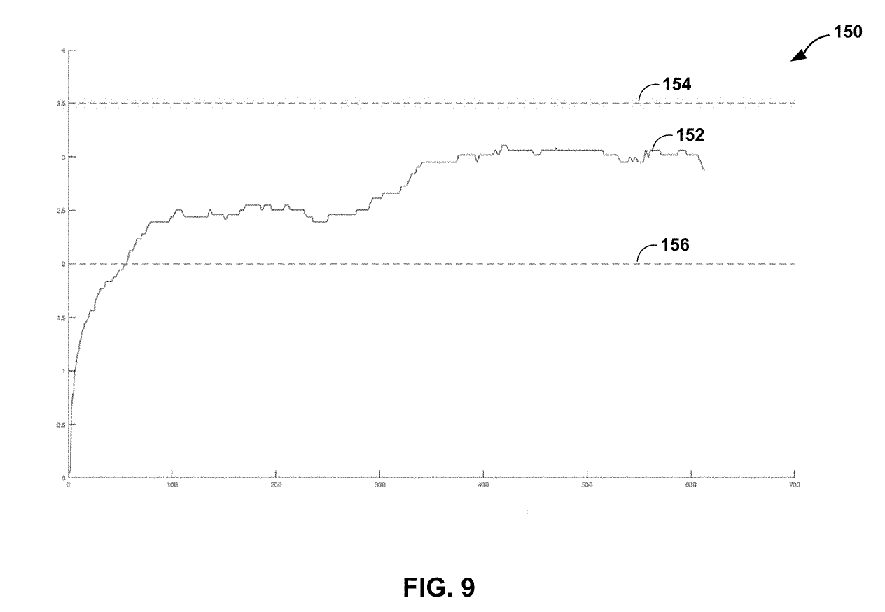

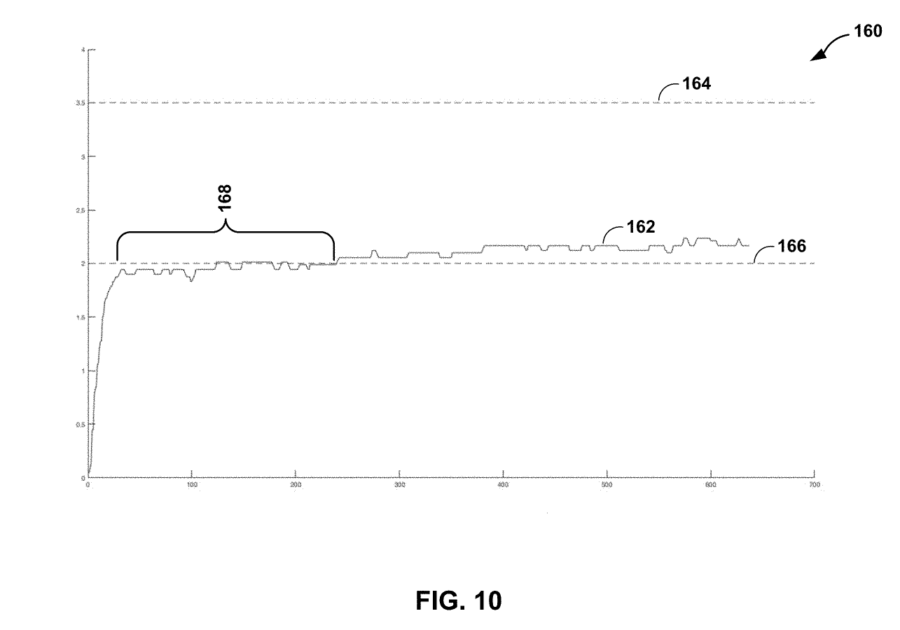

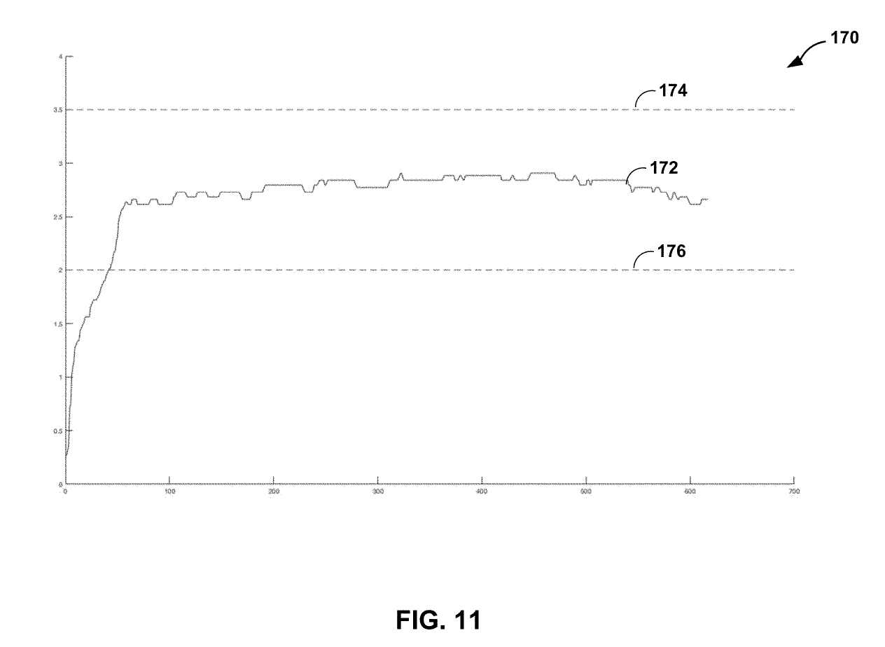

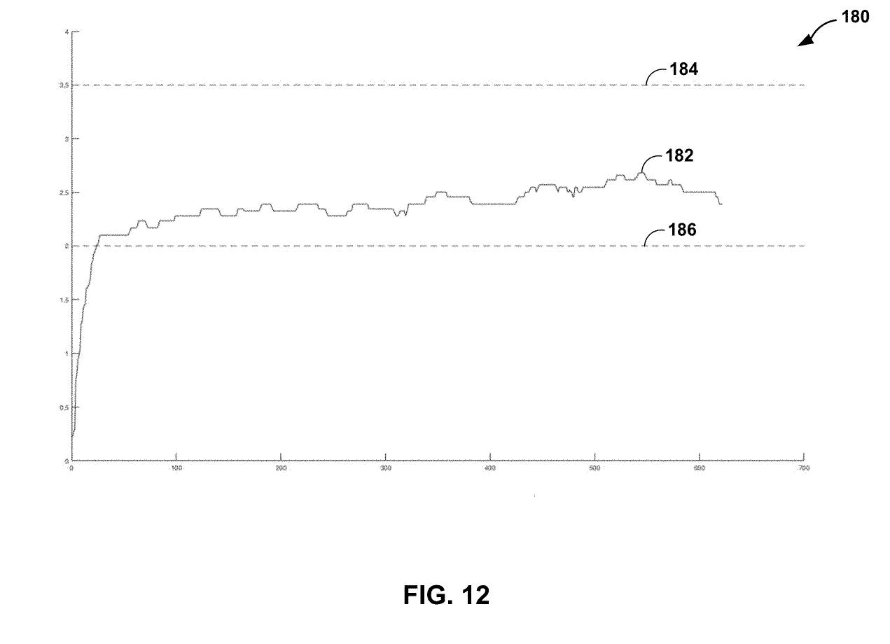

FIGS. 8-12 are example graphical displays illustrating lengths of a target area of an image of a tested component. For example, FIGS. 8-12 show a respective length of a plurality of lengths versus a respective position of a plurality of positions, each for one tested component of five tested components 12. FIGS. 8-12 may include a plot of each respective length of the plurality of lengths 142, 152, 162, 172, and 182. FIGS. 8-12 may include an upper bound and lower bound that represent a predetermined tolerance. For example, the predetermine tolerance may include an upper bound 144, 154, 164, 174, and 184 that indicates a maximum target length of a target area. Similarly, the predetermine tolerance may include a lower bound 146, 156, 166, 176, and 186 that indicates a minimum acceptable target length of a target area. In some examples, a number of lengths of the plurality of lengths, e.g., region 148 of FIG. 8, may be shown to be outside of the predetermined tolerance due to a natural geometry of the target area. However, region 148 may be within tolerance. In some examples, a number of the respective lengths of the plurality of lengths may be outside the tolerance. For example, region 168 of FIG. 10 shows a number of respective lengths of the plurality of lengths that are outside the lower bound of the predetermined tolerance. In examples in which a number of the respective lengths of the plurality of lengths may be outside the tolerance, e.g., region 168 of FIG. 10, the technique illustrated in FIG. 3 may include outputting, by computing device 30 and, more particularly, visualization module 62, an indication to an operator to reexamine, discard, or otherwise address the out of tolerance tested component 12. In some examples, graphical displays similar to FIG. 8-12 may be used, for example, by operators to evaluate the spatial relationship of any one of the masked portion of the substrate, the grit blasted portion of the substrate, the bond coated portion of the substrate, and/or the top coated portion of the substrate to determine if the masked portion of the substrate, the grit blasted portion of the substrate, the bond coated portion of the substrate meets a predetermine tolerance.

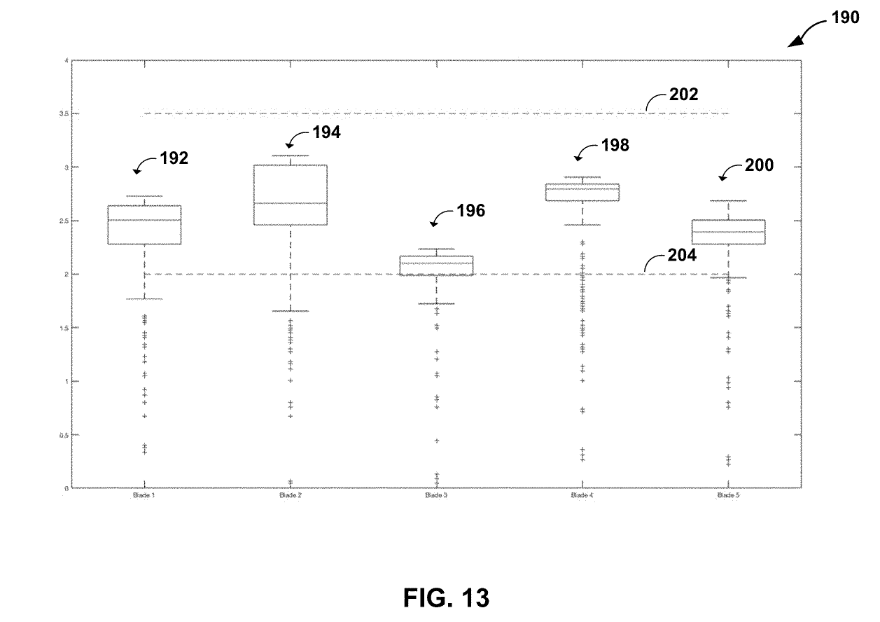

FIG. 13 is an example graphical display illustrating a distribution of lengths of a target area of an image of a tested component. For example, FIG. 13 shows box plots for comparison of a respective distribution of the plurality of lengths from FIGS. 8-12. Like FIGS. 8-12, FIG. 13 may include an upper bound 202 and lower bound 204 that represent a predetermined tolerance. In examples in which a number of the respective lengths of the plurality of lengths may be outside the tolerance, the technique illustrated in FIG. 3 may include outputting, by computing device 30 and, more particularly, visualization module 62, an indication to an operator to reexamine, discard, or otherwise address the out of tolerance tested component 12. In some examples, graphical displays similar to FIG. 13 may be used, for example, by operators to evaluate the spatial relationship of any one of the masked portion of the substrate, the grit blasted portion of the substrate, the bond coated portion of the substrate, and/or the top coated portion of the substrate to determine if the masked portion of the substrate, the grit blasted portion of the substrate, the bond coated portion of the substrate meets a predetermine tolerance.

Various examples have been described. These and other examples are within the scope of the following claims.

1. An apparatus for measuring a feature of a tested component comprising:
a lighting device configured output light to illuminate at least a portion of the tested component;
an imaging device; and
a computing device configured to:
receive, from the imaging device, a first image of the portion of the tested component in a first state;
segment the first image to isolate a first target area of the image from background areas of the first image;
measure a plurality of first lengths of at least one portion of the first target area;
receive, from the imaging device, a second image of the portion of the tested component in a second, different state;
segment the second image to isolate a second target area of the second image from background areas of the second image;
measure a plurality of second lengths of at least one portion of the second target area, wherein a respective first length of the plurality of first lengths corresponds to a respective second length of the plurality of second lengths; and
compare each respective first length of the plurality of first lengths to the corresponding second length of the plurality of second lengths.

2. The apparatus of claim 1, wherein the computing device is further configured to determine whether a difference between each respective first length of the plurality of first lengths and the corresponding second length of the plurality of second lengths is within a predetermined tolerance.

3. The apparatus of claim 1, wherein the computing device is further configured to determine, based on the comparison of each respective first length of the plurality of first lengths and the corresponding second length of the plurality of second lengths, whether the first target area substantially corresponds to the second target area.

4. The apparatus of claim 1, wherein the computing device is further configured to determine, based on the comparison of each respective first length of the plurality of first lengths and the corresponding second length of the plurality of second lengths, whether the second target area is within a predetermined tolerance.

5. The apparatus of claim 1, wherein the computing device is further configured to condition at least one of the first image or the second image by at least one of removing artifacts in the image, resizing a portion of the image, deforming a portion of the image, transforming a portion of the image, or adjusting at least one of a wavelength of light emitted from the lighting device, a color of the image, or a contrast of the image.

6. The apparatus of claim 1, wherein the computing device is further configured to output a graphical display indicative of the spatial relationship of the first target area and the second target area.

7. The apparatus of claim 1, wherein computing device is further configured to:
determine a first change in contrast between a first position in or near the first target area and a second, adjacent position in or near the first target area;
determine, based on the first change in contrast, a first boundary in or near the first target area;
determine a second change in contrast between a third position in or near the first target area and a fourth, adjacent position in or near the first target area; and
determine, based on the second change in contrast, a second boundary in or near the first target area, and
wherein the plurality of first lengths comprise a plurality of distances between the first boundary and the second boundary.

8. The apparatus of claim 7, wherein computing device is further configured to:
determine a third change in contrast between a fifth position in or near the second target area and a sixth, adjacent position in or near the second target area;
determine, based on the third change in contrast, a third boundary in or near the second target area;
determine a fourth change in contrast between a seventh position in or near the second target area and an eighth, adjacent position in or near the second target area; and
determine, based on the fourth change in contrast, a fourth boundary in or near the second target area, and
wherein the plurality of second lengths comprises a plurality of distances between the third boundary and the fourth boundary.

9. The apparatus of claim 1, wherein the computing device is further configured to:
receive, from the imaging device, a standard component image of a portion of a standard component;
segment the standard component image to isolate a standard target area of the standard component image from background areas of the standard component image;
determine, based on the standard target area, at least one of at least one portion of the first target area or at least one portion of the second target area.

10. The apparatus of claim 1, wherein the portion of the tested component is a portion of a turbine blade fin tip.

11. A method of measuring a feature of a tested component, the method comprising:
controlling, by a computing device, a lighting device to illuminate at least a portion of a tested component;
controlling, by the computing device, an imaging device to acquire a first image of the portion of the tested component in a first state;
segmenting, by the computing device, the first image to isolate a first target area of the image from background areas of the first image;
measuring, by the computing device, a plurality of first lengths of at least one portion of the first target area;
controlling, by the computing device, the imaging device to acquire a second image of the portion of the tested component in a second, different state;
segmenting, by the computing device, the second image to isolate a second target area of the second image from background areas of the second image;
measuring, by the computing device, a plurality of second lengths of at least one portion of the second target area, wherein a respective first length of the plurality of first lengths corresponds to a respective second length of the plurality of second lengths; and
comparing, by the computing device, each respective first length of the plurality of first lengths to the corresponding second length of the plurality of second lengths.

12. The method of claim 11, wherein the method further comprises determining, by the computing device, whether a difference between each respective first length of the plurality of first lengths and the corresponding second length of the plurality of second lengths is within a predetermined tolerance.

13. The method of claim 11, wherein the method further comprises determining, by the computing device, based on the comparison of each respective first length of the plurality of first lengths and the corresponding second length of the plurality of second lengths, whether the first target area substantially corresponds to the second target area.

14. The method of claim 11, wherein the method further comprises determining, by the computing device, based on the comparison of each respective first length of the plurality of first lengths and the corresponding second length of the plurality of second lengths, whether the second target area is within a predetermined tolerance.

15. The method of claim 11, wherein the method further comprises conditioning, by the computing device, at least one of the first image or the second image by at least one of removing artifacts in the image, resizing a portion of the image, deforming a portion of the image, transforming a portion of the image, or adjusting at least one of a wavelength of light emitted from the lighting device, a color of the image, or a contrast of the image.

16. The method of claim 11, wherein the method further comprises outputting, by the computing device, a graphical display indicative of the spatial relationship of the first target area and the second target area.

17. The method of claim 11, wherein the method further comprises:
determining, by the computing device, a first change in contrast between a first position in or near the first target area and a second, adjacent position in or near the first target area;
determining, by the computing device, based on the first change in contrast, a first boundary in or near the first target area;
determining, by the computing device, a second change in contrast between a third position in or near the first target area and a fourth, adjacent position in or near the first target area; and
determining, by the computing device, based on the second change in contrast, a second boundary in or near the first target area, and
wherein the plurality of first lengths comprise a plurality of distances between the first boundary and the second boundary.

18. The method of claim 11, wherein the method further comprises:
determining, by the computing device, a third change in contrast between a fifth position in or near the second target area and a sixth, adjacent position in or near the second target area;
determining, by the computing device, based on the third change in contrast, a third boundary in or near the second target area;
determining, by the computing device, a fourth change in contrast between a seventh position in or near the second target area and an eighth, adjacent position in or near the second target area; and
determining, by the computing device, based on the fourth change in contrast, a fourth boundary in or near the second target area, and
wherein the plurality of second lengths comprises a plurality of distances between the third boundary and the fourth boundary.

19. The method of claim 11, wherein the method further comprises
controlling, by the computing device, the imaging device to acquire a standard component image of a portion of a standard component;
segmenting, by the computing device, the standard component image to isolate a standard target area of the standard component image from background areas of the standard component image;
determining, by the computing device, based on the standard target area, at least one of at least one portion of the first target area or at least one portion of the second target area.

20. The method of claim 11, wherein the portion of the tested component is a portion of a turbine blade fin tip.
